(19) United States
(12) Patent Application Publication
(10) Pub. No.: US 2010/0170888 A1
(43) Pub. Date: Jul. 8, 2010

(54) MICRO HEATER, METHOD OF FABRICATING THE SAME AND ENVIRONMENT SENSOR USING THE SAME

(75) Inventors: Hong Yeol LEE, Cheongju-si (KR); Seung Eon Moon, Daejeon (KR); Jong Hyurk Park, Daegu (KR); Jun Hyuk Kwak, Gyeongsan-si (KR); So Jeong Park, Icheon-si (KR); Kang Ho Park, Daejeon (KR); Jong Dae Kim, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/547,375

(22) Filed: Aug. 25, 2009

Related U.S. Application Data
(60) Provisional application No. 61/142,388, filed on Jan. 5, 2009.

(51) Int. Cl. H05B 3/02; H01C 17/02; G01K 13/00

(52) U.S. Cl. 219/542; 29/611; 374/152

(57) ABSTRACT

Provided is a micro heater, which includes an elastic thin film formed by sequentially depositing a first silicon oxide layer, a silicon nitride layer and a second silicon oxide layer, a heating part, a heat spreading structure and a heating part electrode, which are patterned on the elastic thin film, and an insulating layer formed on the heating part, the heat spreading structure and the heating part electrode. Here, the heat spreading structure is perpendicularly connected to the heating part at a connection portion.

### BACKGROUND

1. Field of the Invention

The present invention relates to a micro heater, a method of fabricating the same, and an environment sensor using the same. More particularly, the present invention relates to a micro heater having low power consumption and good thermal efficiency, and an environment sensor using the same.

2. Description of the Related Art

Along with the development of sensor technology, research on a micro heater used in an environment sensor such as a gas sensor has been also developed. Particularly, since low power consumption, good thermal efficiency and good thermal uniformity allowing heat to uniformly spread through an entire heater are required for a micro heater, conventional micro heaters were formed of a heat spreading structure formed in a large plate structure, or formed on a different layer from a heating part.

However, in the large plate-type heat spreading structure, large amounts of heat are lost and flexibility is decreased, and the heat spreading structure formed on a different layer from the heating part has a difficult fabrication process and decreased thermal efficiency.

For these reasons, there is a demand for a micro heater having excellent thermal efficiency and low power consumption to be suitable for an environment sensor, and an environment sensor using the same.

### SUMMARY OF THE INVENTION

The present invention is directed to a micro heater, a method of fabricating the same, and an environment sensor using the same.

The present invention is also directed to a micro heater fabricated in a simple process and having good thermal efficiency and uniformity, a method of fabricating the same, and an environment sensor using the same.

One aspect of the present invention provides a micro heater including: an elastic thin film formed by sequentially depositing a first silicon oxide layer, a silicon nitride layer and a second silicon oxide layer; a heating part, a heat spreading structure and a heating part electrode, which are patterned on the elastic thin film; and an insulating layer formed on the heating part, the heat spreading structure and the heating part electrode. Here, the heat spreading structure is perpendicularly connected to the heating part at a connection portion.

Here, the heating part, the heat spreading structure and the heating part electrode may be formed of any one of poly-silicon, tungsten, aluminum, nickel and platinum. The heating part may be formed to surround the heat spreading structure. Current applied from the heating part may not flow into the heat spreading structure. The heat spreading structure may be connected to the heating part in a Wheatstone bridge type in the circuit aspect. The heat spreading structure may be formed in a multi-ringed structure, in which the rings may be connected to each other at the connection portion. The heat spreading structure may be formed in a circular disc shape. The heating part may be formed to surround the heat spreading structure in a toothed wheel-like pattern, and perpendicularly connected to the heat spreading structure at the connection portion. The pattern shape of the heating part may be transformed to increase an inner resistance thereof.

Another aspect of the present invention provides a method of fabricating a micro heater including: forming an elastic thin film by sequentially depositing a first silicon oxide layer, a silicon nitride layer and a second silicon oxide layer on a silicon substrate; patterning a heating part, a heat spreading structure and a heating part electrode, which are formed of a conductive material, on the elastic thin film; forming an insulating layer on the formed heating part, heat spreading structure and heating part electrode; and etching the silicon substrate under the elastic thin film, wherein the heat spreading structure is perpendicularly connected to the heating part at a connection portion.

According to the exemplary embodiment, in etching the silicon substrate under the elastic thin film, the silicon substrate including the insulating layer may be etched except a portion in which the heating part, the heat spreading structure and the heating part electrode are formed on the elastic thin film.

Still another aspect of the present invention provides an environment sensor including: an elastic thin film formed by sequentially depositing a silicon oxide layer, a silicon nitride layer and a silicon oxide layer; a heating part, a heat spreading structure and a heating part electrode formed on the elastic thin film; an insulating layer formed on the heating part, the heat spreading structure and the heating part electrode; and an environment sensor electrode and an environment sensing material formed on the insulating layer, wherein the heat spreading structure is perpendicularly connected to the heating part at a connection portion.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a cross-sectional view of a micro heater according to a first exemplary embodiment of the present invention;

FIG. 2 is a plan view of the micro heater according to a first exemplary embodiment of the present invention;

FIG. 3 is a cross-sectional view of a micro heater according to a second exemplary embodiment of the present invention;

FIG. 4 is a plan view of the micro heater according to the second exemplary embodiment of the present invention;

FIGS. 5A and 5B show simulation results of the micro heater using ANSYS according to the present invention;

FIGS. 6A and 6B are cross-sectional views of an environment sensor according to an exemplary embodiment of the present invention; and

FIGS. 7A to 7C are plan views showing examples of a heating part and a heat spreading structure applied to a micro heater according to the present invention.

### DETAILED DESCRIPTION OF THE INVENTION

Hereinafter, a micro heater, a method of fabricating the same, and an environment sensor using the same will be described in detail with reference to the accompanying drawings.

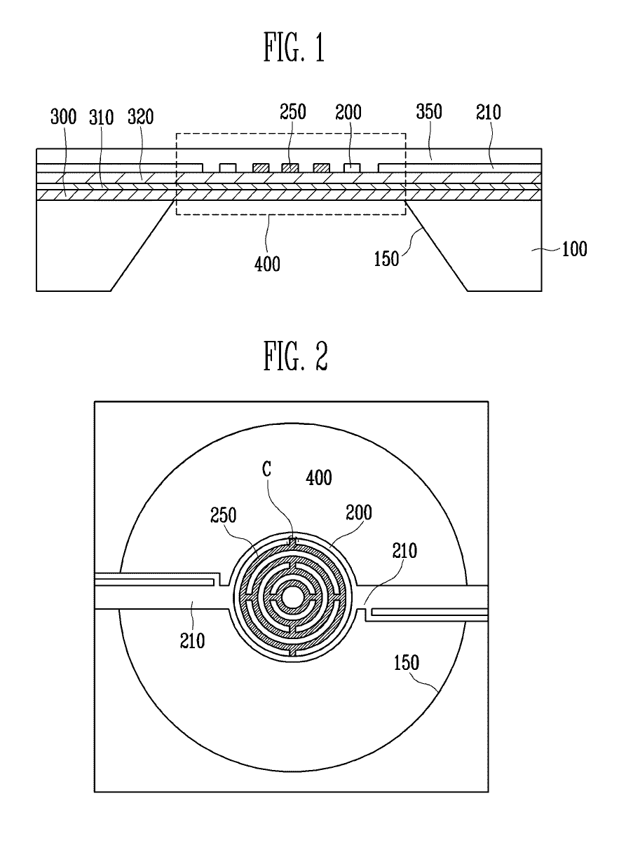

FIG. 1 is a cross-sectional view of a micro heater according to a first exemplary embodiment of the present invention.

Referring to FIG. 1, a micro heater 400 according to the present invention includes a silicon substrate 100, a lower silicon oxide thin film 300, a silicon nitride thin film 310, an upper silicon oxide thin film 320, a heating part electrode (track) 210, a heating part 200, a heat spreading structure 250 and an insulating layer 350.

The micro heater is a heater fabricated by a semiconductor fabrication process, and the heating part 200 converts an electrical signal received from the heating part electrode 210 into thermal energy. The heat spreading structure 250 connected with the heating part 200 collects heat generated from the heating part 200 to uniformly distribute the heat. The micro heater can be fabricated in a small size, so that it can be applied to various sensors and heaters.

The silicon substrate 100 is a substrate for fabricating the micro heater of the present invention, which is the same as a silicon substrate generally used in the semiconductor process. However, since the micro heater of the present invention is fabricated in the form of a thin film, a part in which the micro heater is formed in the silicon substrate is removed through backside etching (150), after the micro heater is completely fabricated on the silicon substrate.

A lower thin film of the micro heater of the present invention is composed of the lower silicon oxide thin film 300, the silicon nitride thin film 310 and the upper silicon oxide thin film 320. The reason why the lower thin film is formed of three layers, not a single layer, is that the lower thin film of the micro heater is bent, and thus may be broken or denatured, once the micro heater is heated. To minimize the denaturation and breakage of the lower thin film, the thin layer is formed by stacking a silicon oxide layer having a compressive stress, and a silicon nitride layer having an extension stress.

The heating part electrode 210 supplies power to the micro heater according to the present invention, which is a conductive wire transmitting the power supplied from the outside to the heating part 200.

The heating part 200 is a circular conductive wire disposed along the heat spreading structure 250. Since it has a lower resistance than the heating part electrode 210, the Joule's heat is generated. The heat spreading structure 250 is in an equilibrium state of a Wheatstone-bridge with the heating part 200 in the circuit aspect, and thus no current flows into the heat spreading structure 250.

The heat spreading structure 250 collects thermal energy transmitted from the heating part 200, and is formed in a multi-ringed structure. Particularly, at a connection portion, the heat spreading structure 250 is perpendicularly connected with the heating part 200, so that they become an electrically equal Wheatstone-bridge in the circuit aspect. Therefore, current is unable to flow into the heat spreading structure 250 which thus collects only heat.

Here, the heating part 200, the heat spreading structure 250 and the heating part electrode 210 may be formed of poly-silicon, tungsten, aluminum, nickel or platinum, and also formed of any material, even a non-metal, having good thermal and electric conductivities and appropriate for such use.

The insulating layer 350 functions as a passivation layer surrounding all the heating part 200, the heat spreading structure 250 and the heating part electrode 210 to be insulated from the outside.

FIG. 2 is a plan view of the micro heater according to a first exemplary embodiment of the present invention.

Referring to FIG. 2, the micro heater 400 of the present invention is fabricated by backside etching the silicon substrate described with reference to FIG. 1 in a circular shape 150, based on the center of the micro heater.

The heating part electrode 210 is a conductive wire connected to the outside of the micro heater 400, and the heating part 200 is a circular conductive wire disposed along the heat spreading structure 250. The heat spreading structure 250 is formed in a multi-ringed structure, which is perpendicularly connected with the heating part 200 at a connection portion.

In this configuration, the heat spreading structure 250 collects thermal energy transmitted from the heating part 200, but no current flows into the heat spreading structure 250 from the heating part 200.

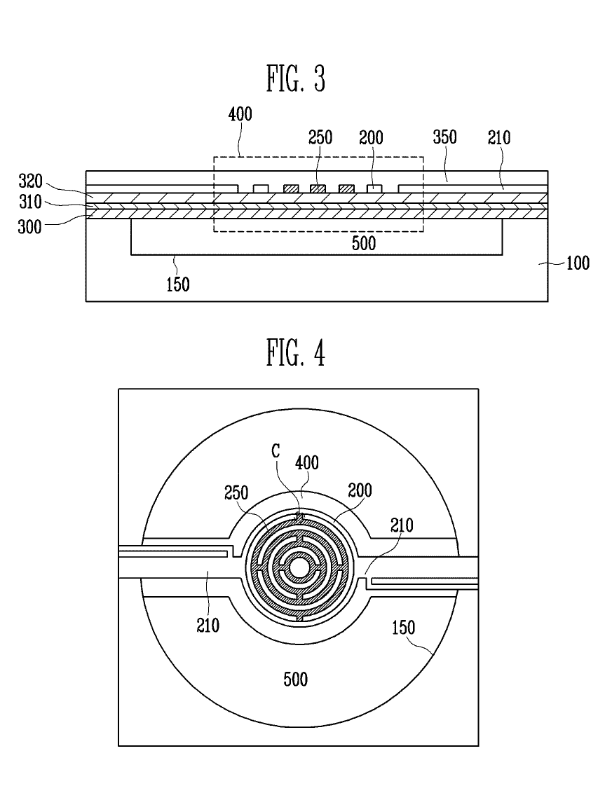

FIG. 3 is a cross-sectional view of a micro heater according to a second exemplary embodiment of the present invention.

Referring to FIG. 3, a micro heater 400 according to the second exemplary embodiment of the present invention includes a silicon substrate 100, a lower silicon oxide thin film 300, a silicon nitride thin film 310, an upper silicon oxide thin film 320, a heating part electrode 210, a heating part 200, a heat spreading structure 250, an insulating layer 350 and a lower cave 500.

The micro heater may be the same as that described with reference to FIG. 1.

The silicon substrate 100 is a substrate for fabricating the micro heater of the present invention, which is the same as the silicon substrate generally used in a semiconductor process. Since the micro heater of the present invention is fabricated in the form of a thin film, the lower cave 500 is formed by etching the lower silicon oxide thin film 300, the silicon nitride thin film 310, the upper silicon oxide thin film 320 and the silicon substrate 100, excluding the micro heater 400 using microfabrication technology, which is different from that described with reference to FIG. 1, after the micro heater is completely fabricated on the silicon substrate.

When the lower cave 500 is thus formed, the surroundings of the heating part 200 and the heat spreading structure 250 are opened in the actual micro heater 400 by etching the substrate, excluding the heating part electrode 210, the heating part 200 and the heat spreading structure 250, which is different from that described with reference to FIG. 1.

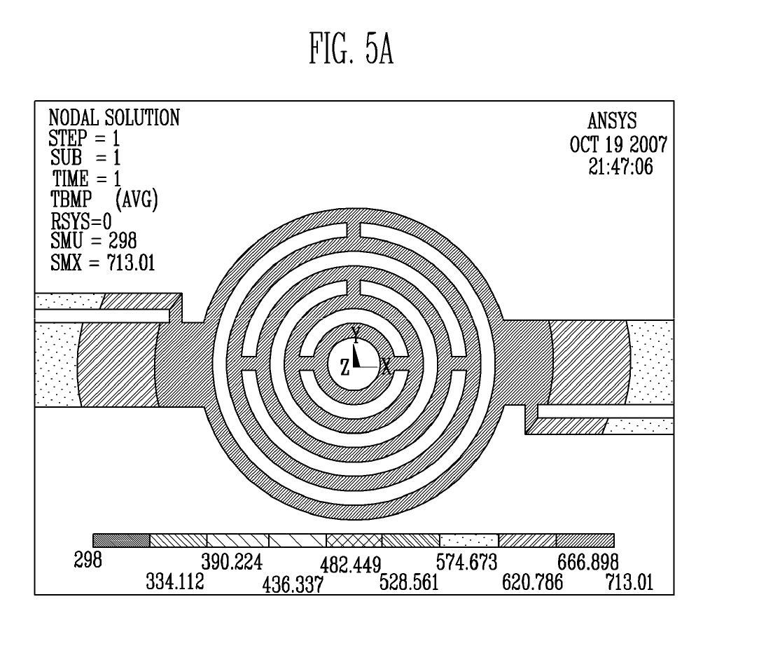

FIG. 4 is a plan view of the micro heater according to a second exemplary embodiment of the present invention.

Referring to FIG. 4, the micro heater according to a second exemplary embodiment of the present invention is fabricated by completely etching the silicon substrate as described in FIG. 3, excluding a part having the micro heater 400 of the present invention.

As shown in FIG. 4, the lower cave 500 is formed by completely etching the substrate around the micro heater 400. Etching the substrate may be performed using the microfabrication technology. In the micro heater 400 fabricated by the above-described method, the lower cave 500 is formed by etching the silicon substrate at the front side using the microfabrication technology to remove unnecessary parts, not by backside etching the silicon substrate.

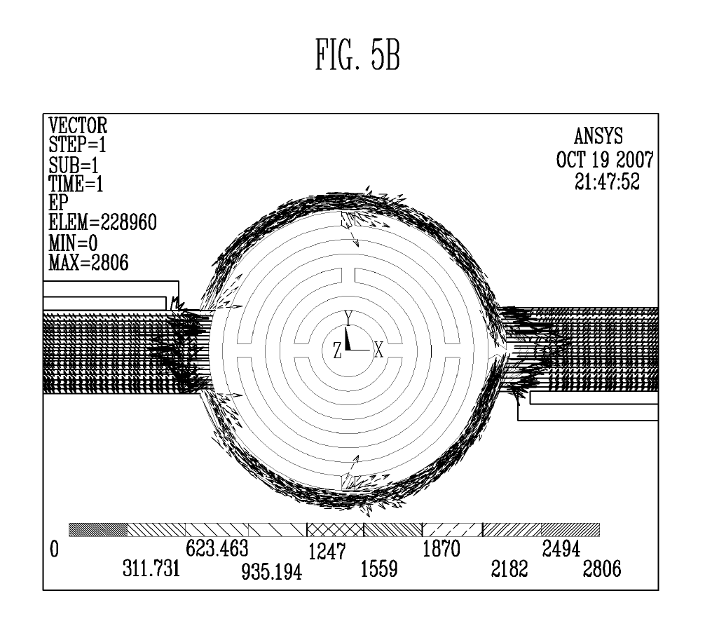

FIGS. 5A and 5B show simulation results of the micro heater using ANSYS according to the present invention.

FIG. 5A shows thermal distribution in the micro heater according to the present invention.

FIG. 5A shows a finite element simulation result when applied power is 25 mW and the heat spreading structure is formed of platinum (Pt). Here, the maximum temperature of the heating part 200 is expected as 713.01K, i.e., 440° C., which can perform properly the performance as the micro heater. Also, as shown in the drawing, thermal uniformity is excellent through the entire heat spreading structure.

FIG. 5B shows current flow into the micro heater according to the present invention.

As described above, the heat spreading structure of the present invention functions as a Wheatstone bridge in the circuit aspect, and therefore the current introduced from the outside does not flow into the heat spreading structure. The simulation result thereof is shown in FIG. 5B.

As shown in FIG. 5B, it is confirmed that the current applied to the heating part electrode and the heating part does not flow into the heat spreading structure.

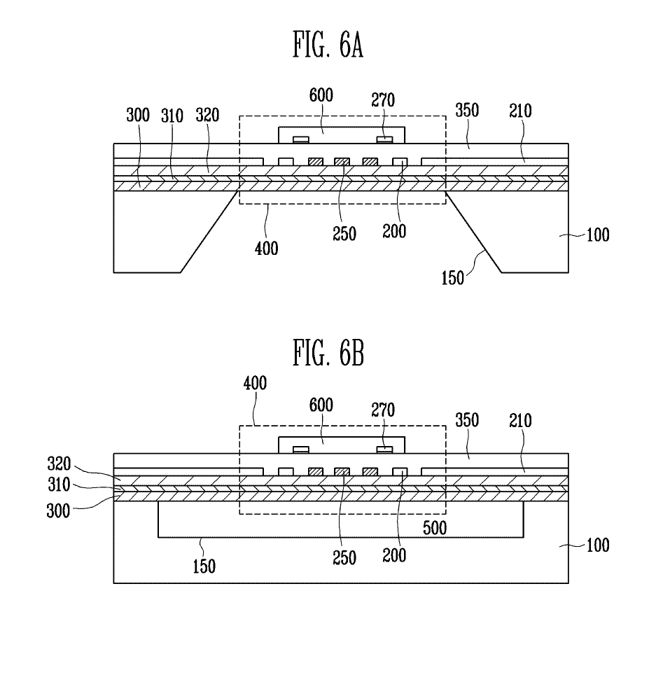

FIGS. 6A and 6B are cross-sectional views of an environment sensor according to an exemplary embodiment of the present invention.

FIG. 6A is a cross-sectional view of a gas sensing device further including a gas sensing electrode 270 and a gas sensing material 600 on the micro heater according to the first exemplary embodiment of the present invention that is described with reference to FIG. 1. FIG. 6B is a cross-sectional view of a gas sensing device further including a gas sensing electrode 270 and a gas sensing material 600 on the micro heater according to the second exemplary embodiment of the present invention that is described with reference to FIG. 3.

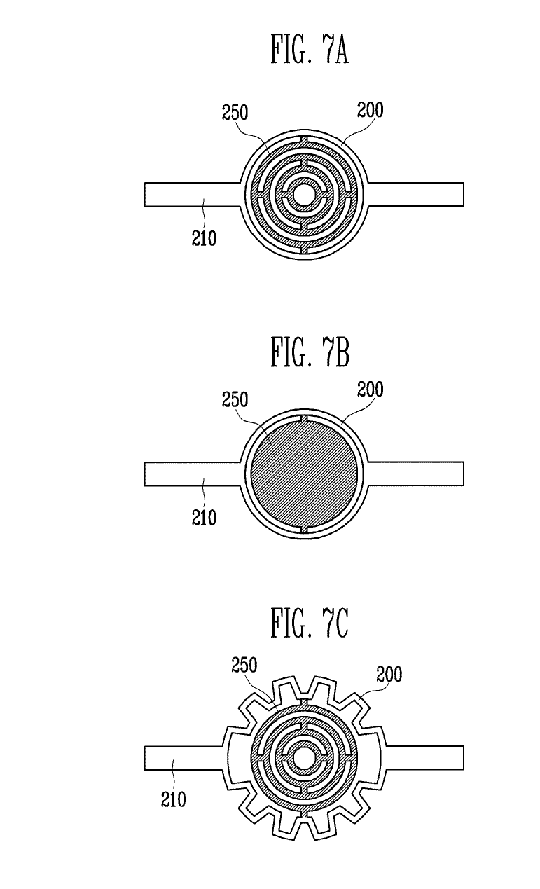

FIGS. 7A to 7C are plan views showing examples of a heating part and a heat spreading structure applied to a micro heater according to the present invention.

FIG. 7A is a plan view of the heating part 200 and the heat spreading structure 250 according to the first and second exemplary embodiments of the present invention that are described with reference to FIGS. 2 and 4. The heating part 200 is formed in a ringed structure, and the heat spreading structure 250 is connected with the heating part 200 in a Wheatstone-bridge structure. The heat spreading structure 250 is formed in a multi-ringed structure. A thermal energy generated from the heating part 200 is collected on the heat spreading structure 250 and uniformly distributed.

FIG. 7B is a plan view of another example of the heat spreading structure 250. The heat spreading structure 250 is formed in a circular disc shape, not a multi-ringed structure. The heat spreading structure 250 can make a fabrication process simple since it does not need to etch a different pattern on the heat spreading structure 250.

FIG. 7C is a plan view of still another example of the heating part 200. The heating part 200 is formed in an indented structure, not a ringed structure. This structure can enhance an electrical resistive component compared to the ringed structure. Resistance is dependant on the shape of the heating part. Thus, the indented pattern is not necessarily the same as shown in the drawing and may be changed to any shape capable of enhancing the resistive component. That is, the resistive component may be enhanced by length extension and reduction of a cross-section area.

Accordingly, the micro heater of the present invention can lose less heat than a conventional micro heater, and be significantly strong against thermal or mechanical denaturation by forming both a silicon oxide layer and a silicon nitride layer on a lower thin film.

In addition to the gas sensing device described with reference to the drawing, the micro heater can be applied to an environment sensor. It is obvious that as the environment sensor of the present invention has more micro heaters, it can be more effective.

Consequently, the present invention provides a micro heater, a method of fabricating the same, and an environment sensor using the same.

More particularly, a micro heater fabricated in a simple process and having good thermal efficiency and thermal uniformity, a method of fabricating the same, and an environment sensor using the same can be provided.

Exemplary embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A micro heater comprising:
an elastic thin film formed by sequentially depositing a first silicon oxide layer, a silicon nitride layer and a second silicon oxide layer;
a heating part, a heat spreading structure and a heating part electrode, which are formed on the elastic thin film; and
an insulating layer patterned on the heating part, the heat spreading structure and the heating part electrode,
wherein the heat spreading structure is perpendicularly connected to the heating part at a connection portion.

2. The micro heater according to claim 1, wherein the heating part, the heat spreading structure and the heating part electrode are formed of any one of poly-silicon, tungsten, aluminum, nickel and platinum.

3. The micro heater according to claim 1, wherein the heating part is formed to surround the heat spreading structure.

4. The micro heater according to claim 1, wherein a current applied from the heating part does not flow into the heat spreading structure.

5. The micro heater according to claim 4, wherein the heat spreading structure is coupled to the heating part in a Wheatstone bridge type in the circuit aspect.

6. The micro heater according to claim 1, wherein the heat spreading structure is formed in a multi-ringed structure, the rings being connected to each other by a connection portion.

7. The micro heater according to claim 1, wherein the heat spreading structure is formed in a circular disc shape.

8. The micro heater according to claim 1, wherein the heating part is formed to surround the heat spreading structure in a toothed wheel-like pattern, and perpendicularly connected to the heat spreading structure at the connection portion.

9. The micro heater according to claim 8, wherein the pattern shape of the heating part is transformed to increase an inner resistance thereof.

10. A method of fabricating a micro heater, comprising:
forming an elastic thin film by sequentially depositing a first silicon oxide layer, a silicon nitride layer and a second silicon oxide layer on a silicon substrate;
patterning a heating part, a heat spreading structure and a heating part electrode, which are formed of a conductive material, on the elastic thin film;
forming an insulating layer on the patterned heating part, heat spreading structure and heating part electrode; and
etching the silicon substrate under the elastic thin film,
wherein the heat spreading structure is perpendicularly connected to the heating part at a connection portion.

11. The method according to claim 10, wherein in etching the silicon substrate under the elastic thin film, the silicon substrate including the insulating layer is etched except a portion in which the heating part, the heat spreading structure and the heating part electrode are formed on the elastic thin film.

12. An environment sensor comprising:
an elastic thin film formed by sequentially depositing a silicon oxide layer, a silicon nitride layer and a silicon oxide layer;
a heating part, a heat spreading structure and a heating part electrode formed on the elastic thin film;
an insulating layer formed on the heating part, the heat spreading structure and the heating part electrode; and
an environment sensor electrode and an environment sensing material formed on the insulating layer,
wherein the heat spreading structure is perpendicularly connected to the heating part at a connection portion.
